(19) United States
(12) Patent Application Publication
(10) Pub. No.: US 2026/0045376 A1
(43) Pub. Date: Feb. 12, 2026

(54) SYSTEM & METHOD FOR 3-D PRINTING A NUCLEAR REACTOR

(71) Applicant: Last Energy Inc., Washington, DC (US)

(72) Inventors: Bret Kugelmass, Austin, TX (US); Mark G. Blomstrom, Inverness, FL (US); Jonathan R. Ritchie, Elgin, TX (US); Christopher D. Muscari, Washington, DC (US); Elizabeth M. May, Hyattsville, MD (US)

(21) Appl. No.: 19/356,880

(22) Filed: Oct. 13, 2025

Related U.S. Application Data
(63) Continuation-in-part of application No. 19/301,579, filed on Aug. 15, 2025.
Application No. 19/301,579 is a continuation of application No. 18/921,964, filed on Oct. 21, 2024, now Pat. No. 12,412,674.
(60) Provisional application No. 63/545,044, filed on Oct. 20, 2023.

(51) Int. Cl. G21C 13/087; G21C 11/08; G21C 13/028; G21C 15/04; G21C 15/12; G21C 15/243; G21C 15/26

(52) U.S. Cl. CPC G21C 13/0875; G21C 11/085; G21C 11/088; G21C 15/12; G21C 13/0285; G21C 15/04; G21C 15/243; G21C 15/26

(57) ABSTRACT

One variation of a system includes a pressure vessel: formed of a set of structural layers arranged in a column; defining a primary internal volume within the column; defining a set of infrastructure receptacles containing a heat exchanger and a pump and arranged above the primary internal volume within the column; defining a primary coolant circuit extending between the primary internal volume and the set of infrastructure receptacles within the column; and defining a secondary coolant circuit extending within the wall and adjacent and fluidly isolated from the primary coolant circuit. The system also includes: a nuclear fuel arranged within the primary internal volume; a primary coolant circulating between the nuclear fuel and the primary coolant circuit; and a secondary coolant circulating between the secondary coolant circuit and an external power generation system. The heat exchanger is configured to transfer thermal energy from the primary coolant to the secondary coolant.

### CROSS-REFERENCE

This Application is a Continuation-in-Part of U.S. patent application Ser. No. 19/301,579, filed on 15 Aug. 2025, which is a continuation of U.S. patent application Ser. No. 18/921,964, filed on 21 Oct. 2024, which claims the benefit of U.S. Provisional Application No. 63/545,044 filed on 20 Oct. 2023, each of which is incorporated in its entirety by this reference.

### TECHNICAL FIELD

This invention relates generally to the field of nuclear reactors and, more specifically, to a new and useful pressure vessel in the field of nuclear reactors.

### BRIEF DESCRIPTION OF THE FIGURES

FIG. 1 is a schematic representation of one variation of a system;

FIGS. 2A and 2B are schematic representations of one variation of the system;

FIG. 3 is a schematic representation of one variation of the system;

FIGS. 4A, 4B, and 4C are flowchart representations of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

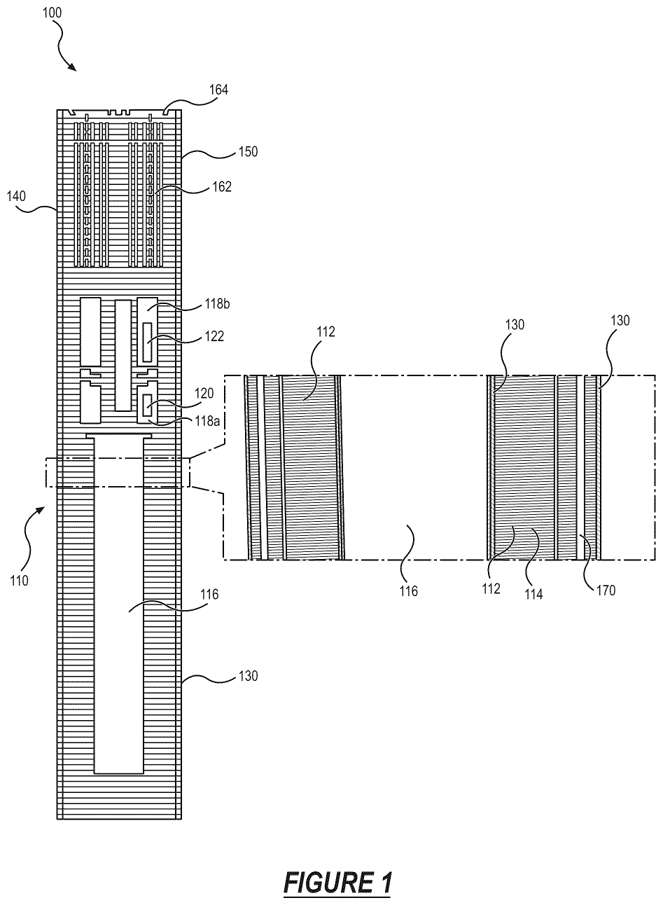

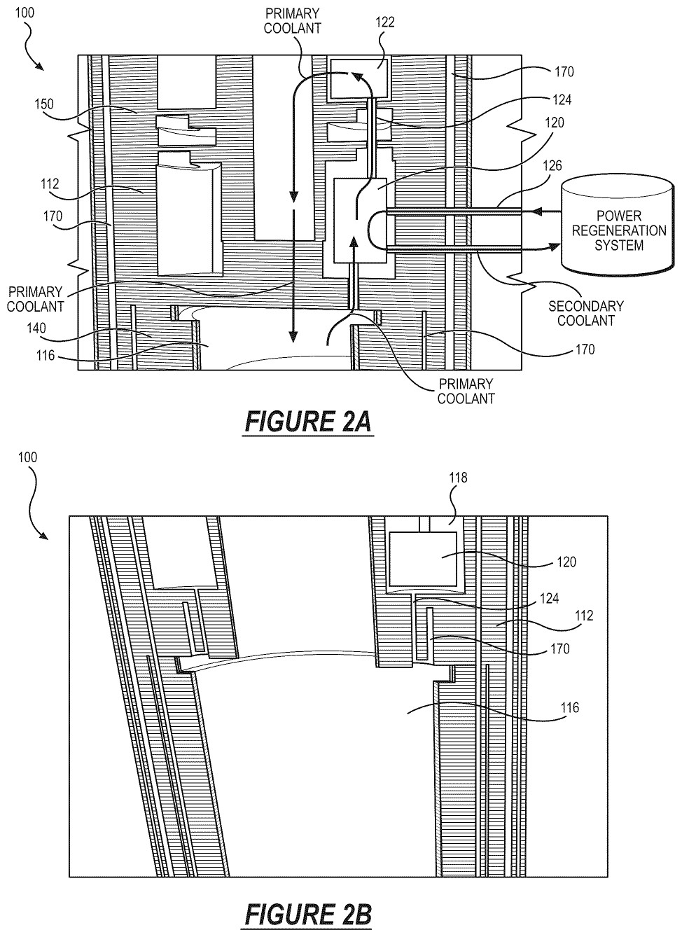

As shown in FIGS. 1, 2A, 2B, 3, 4A, 4B, and 4C, a system 100 includes a pressure vessel 110: including a wall 111 formed of a set of structural layers 112 arranged in a column; defining a primary internal volume 116 within the column; defining a set of infrastructure receptacles 118 arranged above the primary internal volume 116 within the column; defining a primary working fluid circuit 124 extending vertically between the primary internal volume 116 and the set of infrastructure receptacles 118 within the column; defining a secondary working fluid circuit 126 extending vertically within the wall 111 and adjacent and fluidly isolated from the primary working fluid circuit 124. The system 100 also includes: a nuclear fuel arranged within the primary internal volume 116; a primary working fluid sealed within the pressure vessel 110 and circulating between the nuclear fuel and the primary working fluid circuit 124; and a secondary working fluid circulating between the secondary working fluid circuit 126 and an external power generation system.

The system 100 also includes a heat exchanger 120: arranged within a first infrastructure receptacle 118 in the set of infrastructure receptacles 118; fluidly coupled to the primary working fluid circuit 124; and configured to transfer thermal energy from the primary working fluid to the secondary working fluid. The system 100 also includes a set of liners 130: including a set of interior liners arranged within the pressure vessel 110 and lining interior surfaces of the wall 111 facing the primary internal volume 116 and the set of infrastructure receptacles 118; including an exterior liner arranged about an exterior surface of the wall 111; and configured to yield against the wall 111 under internal pressure to form a seal between the wall 111 and the primary internal volume 116.

### 2. Method: Pressure Vessel Assembly

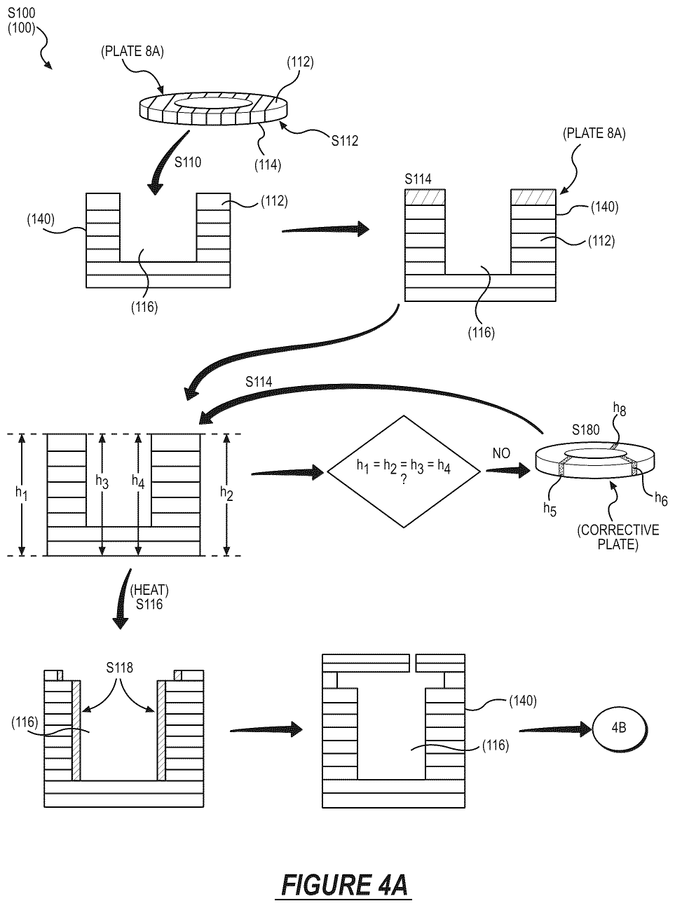

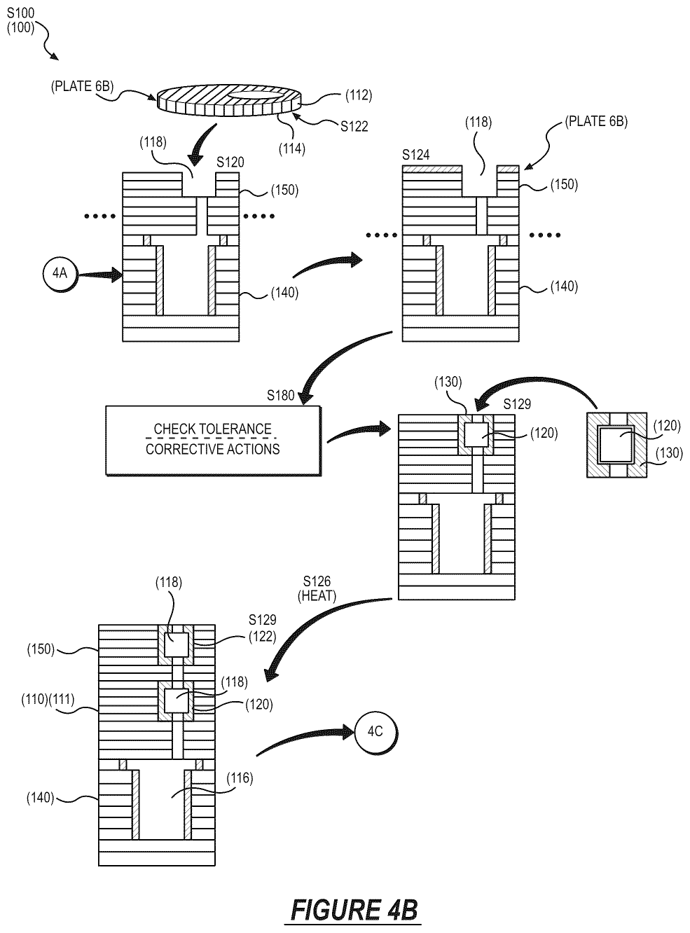

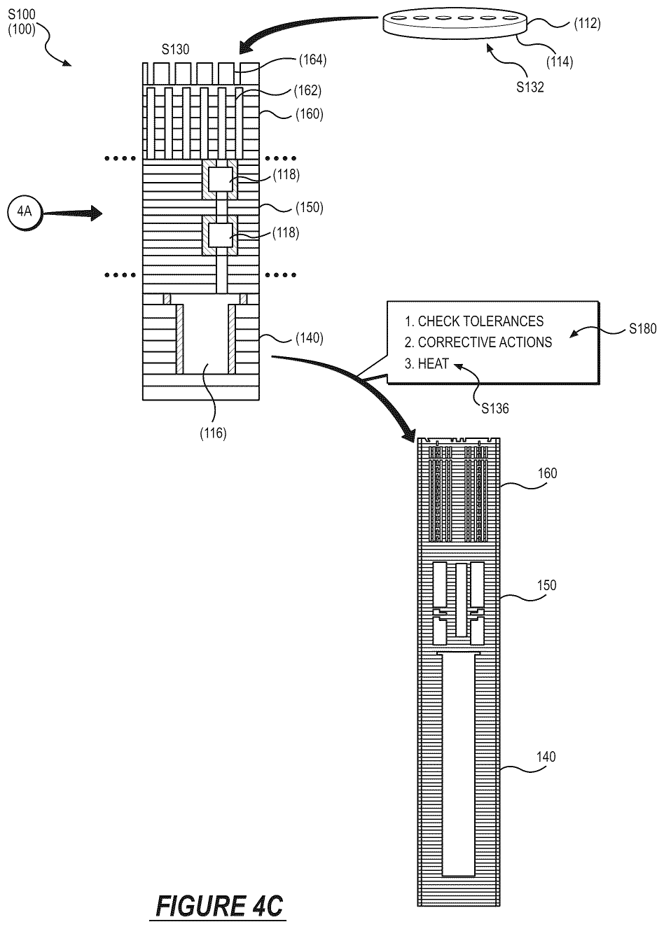

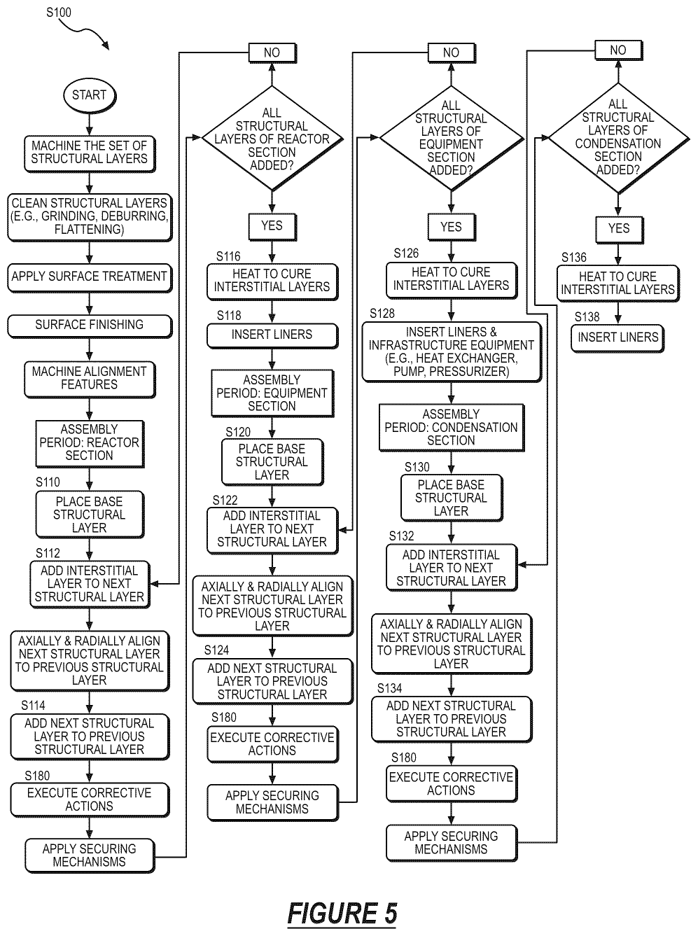

As shown in FIGS. 4A, 4B, 4C, and 5, a method S100 includes, during a first assembly period, locating a base structural layer 112 on a build surface and arranging a first subset of structural layers 112 in a reactor section 140 of a column—defining a primary internal volume 116 configured to house a nuclear fuel—in Block S110, including, for each structural layer 112 in the first subset of structural layers 112: applying an interstitial layer 114 to a surface of the structural layer 112 in Block S112; coaxially and radially aligning the structural layer 112 to the base structural layer 112; and affixing the structural layer 112 to a preceding structural layer 112, in the first subset of structural layers 112, in the column via the interstitial layer 114 interposed between the structural layer 112 and the preceding structural layer 112, the first structural layer 112 coaxially aligned to the preceding structural layer 112 and the base structural layer 112 in Block S114. The method S100 further includes, during the first assembly period: heating the reactor section 140 of the column to a first target temperature to cure interstitial layers 114 between structural layers 112 in the first subset of structural layers 112 in Block S116; and applying a first set of liners 130 to interior walls of the reactor section 140 encapsulating the primary interior volume, the first set of liners 130 configured to form a seal between the interior wall 111 and the primary internal volume 116 in Block S118.

The method S100 further includes, during a second assembly period succeeding the first assembly period, arranging a second subset of structural layers 112 in an equipment section 150 of the column defining a set of infrastructure receptacles 118 in Block S120, including, for each structural layer 112 in the second subset of structural layers 112: applying an interstitial layer 114 to a surface of the structural layer 112 in Block S122; coaxially and radially aligning the structural layer 112 to the first subset of structural layers 112; and affixing the structural layer 112 to a preceding structural layer 112, in the second subset of structural layers 112, in the column via the interstitial layer 114 interposed between the structural layer 112 and the preceding structural layer 112, the structural layer 112 coaxially aligned to the preceding structural layer 112, the first subset of structural layers 112, and the base plate in Block S124. The method S100 further includes, during the second assembly period: heating the equipment section 150 of the column to a second target temperature to cure interstitial layers between structural layers 112 in the second subset of structural layers 112 in Block S126; applying a second set of liners 130 to interior walls of the equipment section 150 lining the set of infrastructure receptacles 118 in Block S128; installing a heat exchanger 120 in a first infrastructure receptacle 118 in the set of infrastructure receptacles 118 in Block S129; and installing a pump 122 in a second infrastructure receptacle 118, in the set of infrastructure receptacles 118, above the first infrastructure receptacle 118 within the column in Block S129.

The method S100 further includes, during a third assembly period succeeding the second assembly period, arranging a third subset of structural layers 112 in a condensation section 160 of the column defining a set of slots configured to enable airflow through the column to promote convection cooling in Block S130, including, for each structural layer 112 in the third subset of structural layers 112: applying an interstitial layer 114 to a surface of the structural layer 112 in Block S132; coaxially and radially aligning the structural layer 112 to the second subset of structural layers 112; and affixing the structural layer 112 to a preceding structural layer 112, in the third subset of structural layers 112, in the column via the interstitial layer 114 interposed between the structural layer 112 and the preceding structural layer 112, the structural layer 112 coaxially aligned to the preceding structural layer 112, the second subset of structural layers 112, the first subset of structural layers 112, and the base plate in Block S134. The method S100 further includes, during the third assembly period: heating the condensation section of the column to a third target temperature to cure interstitial layers between structural layers in the third subset of structural layers in Block S136; and applying a third set of liners 130 to interior walls of the condensation section 160 lining the set of airflow slots 164 in Block S138.

In one variation, the method S100 further includes, during a preparation period preceding the first assembly period: machining the first subset of structural layers 112 to: define the primary internal volume 116 when arranged in the column and define a first set of alignment features 170; machining the second subset of structural layers 112 to define the set of infrastructure receptacles 118 when arranged in the column; and define a second set of alignment features 170; machining the third subset of structural layers 112 to: define the set of slots and a set of condensation chambers 162 when arranged in the column and define a third set of alignment features 170; exposing the set of structural layers 112 to a chemical reagent to remove contaminants from surfaces of the plate; polishing the set of structural layers 112 to achieve a target finish grade; and applying a surface treatment to the set of structural layers 112. In this variation, Blocks of the method S100 include: radially aligning a first subset of alignment features 170, in the first set of alignment features 170, of the structural layer 112 with a second subset of alignment features 170, in the first set of alignment features 170, of the preceding structural layer 112; radially aligning a third subset of alignment features 170, in the second set of alignment features 170, of the structural layer 112 with a fourth subset of alignment features 170, in the second set of alignment features 170, of the preceding structural layer 112; and radially aligning a fifth subset of alignment features 170, in the third set of alignment features 170, of the structural layer 112 with a sixth subset of alignment features 170, in the third set of alignment features 170, of the preceding structural layer 112.

One variation of the method S100 includes, during a first assembly period, locating a base structural layer 112, in a set of structural layers 112, on a build surface, and, arranging a first subset of structural layers 112, in the set of structural layers 112, in a reactor section of a column defining a primary internal volume 116 configured to house a nuclear fuel, including, for each structural layer 112 in the first subset of structural layer 112s 112: applying an interstitial layer 114 to a surface of the structural layer 112; coaxially and radially aligning the structural layer 112 to the base structural layer 112; and affixing the structural layer 112 to a preceding structural layer 112, in the first subset of structural layers 112, in the column via the interstitial layer 114 interposed between the structural layer 112 and the preceding structural layer 112, the first structural layer 112 coaxially aligned to the preceding structural layer 112 and the base structural layer 112. The method S100 further includes, during the first assembly period, applying a first set of liners 130 to interior walls of the reactor section encapsulating the primary internal volume 116, the first set of liners 130 configured to form a seal between the interior wall and the primary internal volume 116. In this variation, the method S100 further includes, during a second assembly period succeeding the first assembly period, arranging a second subset of structural layers 112, in the set of structural layers 112, in an equipment section of the column defining a set of infrastructure receptacles 118, including, for each structural layer 112 in the second subset of structural layers 112: applying an interstitial layer 114 to a surface of the structural layer 112; coaxially and radially aligning the structural layer 112 to the first subset of structural layers 112; and affixing the structural layer 112 to a preceding structural layer 112, in the second subset of structural layers 112, in the column via the interstitial layer 114 interposed between the structural layer 112 and the preceding structural layer 112, the structural layer 112 coaxially aligned to the preceding structural layer 112, the first subset of structural layers 112, and the base plate. The method S100 further includes, during the second assembly period: applying a second set of liners 130 to interior walls of the equipment section lining the set of infrastructure receptacles 118; installing a heat exchanger 120 in a first infrastructure receptacle in the set of infrastructure receptacles 118; and installing a pump 122 in a second infrastructure receptacle 118, in the set of infrastructure receptacles 118, above the first infrastructure receptacle 118 within the column.

### 3. Applications

Generally, the system 100 includes: a nuclear reactor; a pressure vessel 110 formed of a set of structural layers 112 stacked in a column; a heat exchanger 120 configured to transfer thermal energy from a primary working fluid (e.g., water) contained within the pressure vessel 110 to a secondary working fluid; a pump 122 configured to draw the primary working fluid through the heat exchanger 120 for cooling via transfer of thermal energy into the secondary working fluid; and a set of liners 130—applied to interior and exterior walls of the column formed of the set of structural layers 112—configured to yield against these walls under high internal pressures to form a seal between internal volumes of the pressure vessel 110 and the set of structural layers 112, thereby preventing leakage of the primary working fluid from within the pressure vessel 110.

In particular, the set of structural layers 112 (e.g., “2.5D” structural layers) can thus be stacked to form a three-dimensional column defining: a primary internal volume 116 configured to contain a nuclear fuel; a set of infrastructure receptacles configured to contain equipment such as the heat exchanger, the pump, a pressurizer, etc.; a set of condensation chambers 162 configured to receive steam from the primary working fluid circuit 124 during emergency conditions; and a set of airflow slots 164 configured to enable airflow through the column to promote convection cooling.

For example, the pressure vessel 110 can be formed by iteratively stacking the set of structural layers 112 in a column to form a cylindrical wall 111 defining the primary internal volume 116 and the set of infrastructure receptacles 118. An interstitial layer (e.g., an adhesive layer) 114 can be applied to each structural layer, in the set of structural layers, prior to affixing the structural layer to a preceding structural layer in the column during assembly. Each interstitial layer 114 can thus be configured to: promote bonding of adjacent structural layers 112 in the column; form a seal between gaps or imperfections in adjacent structural layers 112; and maintain structural and bonding integrity at nuclear reactor operating temperatures.

During assembly of the set of structural layers 112 into the column, additional components of the system 100—including the set of liners 130, the heat exchanger 120, the pump 122, etc.—can be inserted into the primary internal volume 116 and the set of infrastructure receptacles 118 accordingly, such as prior to stacking of a structural layer 112 onto the column that seals off these internal volumes. In one example, the pressure vessel 110 defines a cylindrical structure—exhibiting a diameter between approximately 10 and 12 feet and a height between approximately 30 and 60 feet, or approximately 45 feet—configured to be partially buried underground (e.g., buried below the condensation section 160). Therefore, the system 100 can be configured to supply clean nuclear energy at relatively large scale, such as without requiring diffusion bonding between structural layers forming the pressure vessel 110, thereby significantly reducing costs associated with manufacturing of the pressure vessel 110.

In one implementation, the set of liners 130 includes: a set of internal liners applied to interior surfaces of the wall 111 formed of the set of structural layers 112; and an outer sleeve applied to exterior surfaces of the wall 111 and configured to protect the pressure vessel 110 from external elements, such as including soil corrosion and/or other environmental exposures. In this implementation, the set of liners 130 can be formed of a material—such as including 316 stainless steel, 316L stainless steel, zirconium, various zircaloy alloys, various inconel alloys, various hastelloy alloys, and/or other such high-temperature rated materials—configured to withstand repeated heating and cooling cycles (e.g., during startup and shutdown) without fracturing or failing. Furthermore, the set of internal liners—formed of the stainless steel material—exhibit chemical compatibility with the primary coolant (e.g., water), thereby minimizing a rate of corrosion of these internal liners due to contact with the primary coolant. Furthermore, the set of structural layers 112 can similarly be formed of the stainless steel material, such that the set of liners 130 and the set of structural layers 112 exhibit approximately uniform vertical growth and/or shrinkage responsive to temperature fluctuations within the pressure vessel 110, thereby reducing complexity of the system 100 by eliminating dissimilar material interfaces while maintaining corrosion resistance throughout the wall 111 of the pressure vessel 110 and thus preventing leakage of the primary coolant from within the pressure vessel 110.

Generally, the system 100 can be assembled via an additive manufacturing process (e.g., approximating a 3-D printing process and/or a laminated object manufacturing process) including: sequentially stacking structural layers 112 (e.g., 2.5D metallic sheets)—cut to define the set of infrastructure receptacles 118, the primary internal volume 116, the primary working fluid circuit 124, the secondary working fluid circuit 126, etc.—on a build platform or surface; adhesively bonding each structural layer 112 to a preceding structural layer 112 via an interstitial layer 114 (e.g., an adhesive layer) applied to each structural layer 112; progressively building a 3-D column—layer by layer—forming the pressure vessel 110 and/or system 100 from these 2.5D structural layers 112; and, during assembly of the set of structural layers 112, inserting the set of liners 130—configured to seal interfaces between structural layers 112 and withstand repeated heating and cooling cycles to hinder differential thermal expansion of structural layers 112 across the 3-D column—into corresponding features defined by the (stacked) set of structural layers 112 forming the 3-D column.

Therefore, the system 100 can thus be manufactured via sequential addition and bonding of precision-machined, 2.5D structural layers 112 to form a complex, 3-D structure integrating complex internal geometries—including the primary working fluid circuit 124, the secondary working fluid circuit 126, the set of infrastructure receptacles 118, the primary internal volume 116, etc.—configured to house various components (e.g., the set of liners 130, the heat exchanger 120, the pump 130) of the system 100.

### 4. Hierarchy and Terms

The system 100 is described as including a pressure vessel 110 formed of a set of structural layers 112 arranged in a column. Generally, the set of structural layers 112 can define a metallic (e.g., steel, stainless steel, ferrous) sheet or “2.5D” structure (e.g., a plate). For example, each structural layer 112 can be machined to define a thickness between 1/100,000 inches and twelve inches.

Furthermore, the system 100 is described as including a set of interstitial layers 114 interposed between structural layers 112 in the column forming the pressure vessel 110. Generally, each interstitial layer 114 can define an “adhesive” layer configured to bond adjacent structural layers 112 in the column. For example, each interstitial layer 114 can be formed of a brazing foil material (e.g., nickel-based, silver-based, copper-based), a polymer material (e.g., an epoxy), a ceramic material, etc.

### 5. Pressure Vessel

Generally, the pressure vessel 110 includes a wall 111—formed of a set of structural layers 112 arranged in a column—enclosing a primary internal volume 116 and a set of infrastructure receptacles 118. The primary internal volume 116 is configured to house a nuclear fuel and the set of infrastructure receptacles 118—arranged vertically above the primary internal volume 116 within the column—is configured to house a set of heat exchangers 120 and/or a set of pumps 130.

In particular, the pressure vessel 110—assembled via Blocks of the method S100 (as further described below)—defines: a reactor section 140—formed of a first subset of structural layers 112 stacked coaxially—forming a base of the pressure vessel 110 and defining the primary internal volume 116; an equipment section 150—formed of a second subset of structural layers 112 stacked coaxially the first subset of structural layers 112—arranged vertically above the reactor section 140 within the column and defining the set of infrastructure receptacles 118; and a condensation section 160—formed of a third subset of structural layers 112 stacked coaxially the first and second subsets of structural layers 112—arranged vertically above the equipment section 150 within the column and defining a set of slots configured to enable airflow through the column for convective cooling of an interior of the pressure vessel 110.

The set of structural layers 112—including the first, second, and third subsets of structural layers 112—can define a stack of annuli to form a cylindrical pressure vessel 110 configured to contain high pressures. In one example, the pressure vessel 110 can: define a cylindrical geometry exhibiting a uniform diameter of approximately twelve feet; exhibit a height between 20 and 60 feet; and contain pressures up to 10,000 psi within the primary internal volume 116.

### 5.1 Reactor Section

Generally, the pressure vessel 110 includes a reactor section 140 defining a primary internal volume 116 within the column.

The wall of the reactor section 140—contiguous and/or coextensive with the wall of the equipment section 150 and/or condensation section 160—defines an inner surface bounding the primary internal volume 116. The primary internal volume 116 defines a sealed cavity configured to contain: a nuclear reactor (e.g., a nuclear core containing nuclear fuel); and a volume of primary working fluid (hereinafter “primary coolant”) (e.g., water). The inner surface defines: a reactor outlet configured to direct primary coolant from the primary internal volume 116—of the reactor section 140—toward the equipment section 150 (e.g., toward the heat exchanger 120 of the equipment section 150); and a reactor inlet configured to direct (cooled) primary coolant from the equipment section 150 into the primary internal volume 116.

In one implementation, the reactor section 140 of the pressure vessel 110 includes a set of liners 130 (as further described below)—lining inner surfaces of the wall 111—configured to form a seal between the wall 111 and the primary internal volume 116.

### 5.2 Equipment Section

Generally, the pressure vessel 110 includes an equipment section 150—arranged vertically above the reactor section 140 within the column—defining a set of infrastructure receptacles 118. The equipment section 150 includes: a heat exchanger 120 arranged within a first infrastructure receptacle 118a in the set of infrastructure receptacles 118; and a pump 122 arranged within a second infrastructure receptacle 118b, in the set of infrastructure receptacles 118, vertically above the first infrastructure receptacle 118 within the column. For example, the equipment section 150 can include: a micro-channel heat exchanger 120 or a printed circuit heat exchanger 120 arranged vertically above the primary internal volume 116 within the column; and a pump 122—arranged vertically above the heat exchanger 120 within the column—configured to draw fluid upward from the primary internal volume 116 and through the heat exchanger 120 with sufficient fluid velocity to enable a target amount of heat exchange between the primary coolant and the secondary coolant. By arranging the pump 122 above the heat exchanger 120 within the column, cooler primary coolant flowing out from the heat exchanger 120 flows through the pump 122, thereby increasing longevity of the pump 122.

The equipment section 150 can also include a pressurizer arranged within a third infrastructure receptacle 118, in the set of infrastructure receptacles 118, and configured to maintain pressure of the primary coolant within a target pressure range.

In one implementation, the wall 111 of the equipment section 150—contiguous the wall 111 of the reactor section 140 and/or condensation section 160—defines: a heat exchanger inlet configured to direct primary coolant from the reactor section 140 into the first infrastructure receptacle 118 containing the heat exchanger 120; a heat exchanger outlet configured to direct primary coolant from the first infrastructure receptacle 118 toward the second infrastructure receptacle 118 containing the pump 122; a pump inlet configured to direct primary coolant from the first infrastructure receptacle 118 into the second infrastructure receptacle 118; and a pump outlet configured to direct primary coolant outward from the second infrastructure receptacle 118 for return to the primary internal volume 116 of the reactor section 140.

Furthermore, the wall 111 of the equipment section 150 defines: a secondary heat exchanger inlet configured to direct a secondary working fluid (hereinafter “secondary coolant”) into the pressure vessel 110 and/or toward the heat exchanger 120 contained within the first infrastructure receptacle 118; and a secondary heat exchanger outlet configured to direct the secondary coolant out of the pressure vessel 110 and to an external thermal power generation system for conversion of thermal energy into electricity.

In one implementation, the equipment section 150 of the pressure vessel 110 also includes a set of liners 130 lining inner surfaces of the wall 111 encapsulating the set of infrastructure receptacles 118 and configured to form a seal between the wall 111 and the set of infrastructure receptacles 118 (e.g., containing the heat exchanger 120 and the pump 122).

### 5.3 Condensation Chambers

In one implementation, the pressure vessel 110 includes a condensation section 160—arranged vertically above the equipment section 150 within the column—defining a set of condensation chambers 162 and a set of airflow slots 164 (or “vents’) configured to: enable ambient airflow through the column; and enable relief from heat released by the reactor section 140 and/or equipment section 150 responsive to an accident condition.

In particular, the condensation section 160 occupies an upper region of the pressure vessel 110 and extends seated above ground level (when deployed) to enable passive air circulation into a set of condensation chambers 162. The condensation section 160 can define an array of condensation chambers 162 configured to provide emergency heat removal via passive mechanisms during loss-of-coolant accident conditions. Each condensation chamber, in the array of condensation chambers 162, can function as a steam condensation vessel that operates without electrical power or operator intervention. The set of condensation chambers 162 can be configured to receive steam from the primary working fluid circuit 124 during emergency conditions, such as responsive to primary coolant exiting the reactor section 140 and/or equipment section 150. The steam can condense on the interior walls of the set of condensation chambers 162, releasing latent heat to the surrounding wall 111 formed of the set of structural layers 112.

The set of condensation chambers 162 can be formed via alignment of voids in a subset of structural layers 112 forming the condensation section 160. Each condensation chamber can define a vertical cylindrical volume extending through multiple structural layers 112 to create continuous chambers spanning a height of the condensation section 160.

The set of airflow slots 164 can be machined into an exterior surface of the condensation section 160 to create air circulation passages that enable natural convection cooling. The set of airflow slots 164 can define geometries configured to promote upward airflow about the exterior surface of the condensation section 160. Each airflow slot can define a narrow opening extending vertically along the exterior surface of the condensation section 160. The set of airflow slots 164 can be positioned circumferentially around the condensation section 160 to provide uniform air circulation around the exterior surface of the condensation section 160. Furthermore, the set of airflow slots 164 can be arranged according to target specifications—such as including target spacing and/or sizing metrics—configured to maximize heat transfer while maintaining structural integrity of the condensation section 160.

### 5.3.1 Metallic Flooding Material

In one variation, the system 100 further includes a metallic flooding material arranged within a coolant reservoir. The metallic flooding material can define a metal mixture (or composition, compound, or alloy) such as a lead-bismuth eutectic that: occupies a liquid state within an operating temperature range of the nuclear fuel; and is configured to flood the primary internal volume 116 during emergency conditions exceeding the operating temperature range. In one example, the coolant reservoir can: be arranged within the equipment section 150 or between the equipment section 150 and the condensation section 160; and define a toroidal geometry configured to contain the metallic flooding material during normal operation. The system 100 can further include a set of melt seals arranged on the coolant reservoir and configured to: retain the metallic flooding material within the coolant reservoir during operation within the operating temperature range; and melt at temperatures exceeding the operating temperature range to release the metallic flooding material into the primary internal volume. The metallic flooding material can be configured to: displace primary working fluid from the primary internal volume 116; encase the nuclear fuel; absorb neutron radiation to reduce fission reaction rates; absorb decay heat from the nuclear fuel; and transfer thermal energy from the nuclear fuel to the wall 111 and surrounding environment via natural convection. The metallic flooding material can therefore cooperate with the set of condensation section 160 to cool the primary internal volume 116 during emergency conditions.

### 5.4 Primary Working Fluid Circuit

Generally, the pressure vessel 110 includes a primary working fluid circuit 124 configured to circulate the primary coolant (e.g., water). The pressure vessel 110 seals the primary coolant within the primary internal volume 116 and the set of infrastructure receptacles 118 enclosed by the wall 111. Therefore, the primary working fluid circuit 124 is isolated from the secondary working fluid circuit 126 to prevent the primary coolant from interfacing (e.g., mixing) with the secondary coolant.

The primary coolant includes water configured to: moderate the fission reaction of the nuclear fuel; and absorb thermal energy (e.g., heat) from the nuclear fuel to cool the nuclear fuel. The primary coolant is further sealed within the pressure vessel 110 and configured to: circulate through the primary internal volume 116, the heat exchanger 120, and the pump 122; and distribute thermal energy, output by the nuclear fuel via a fission reaction, into the secondary coolant via the heat exchanger 120. However, the primary coolant can include any other non-corrosive and thermally conductive fluid to cool the nuclear fuel and distribute thermal energy into the secondary coolant.

Generally, the primary working fluid circuit 124 is configured to direct the primary coolant: from the primary internal volume 116 at temperatures within a first temperature range toward a heat exchanger inlet of the heat exchanger 120; from a heat exchanger outlet of the heat exchanger 120—at temperatures within a second temperature range less than the first temperature range—toward a pump inlet of the pump 122; and from a pump outlet of the pump 122 toward the primary internal volume 116.

### 5.5 Secondary Working Fluid Circuit

Generally, the pressure vessel 110 includes a secondary working fluid circuit 126 configured to circulate a secondary coolant (e.g., water, salt). The secondary working fluid circuit 126 directs the secondary coolant through or across the heat exchanger 120—such that the secondary coolant remains fluidly isolated from the primary coolant—to absorb thermal energy from the primary coolant flowing through or across the heat exchanger 120 via the primary working fluid circuit 124.

In particular, the secondary working fluid circuit 126 originates and terminates at an external thermal power generation system. Alternatively, the secondary working fluid circuit 126 can: originate at a working fluid reservoir (or “coolant reservoir”) external to the pressure vessel 110; and terminate at an external thermal power generation system. The secondary working fluid circuit 126 can thus define a recycling loop that directs cooled secondary coolant out of the external thermal power generation system and back into the coolant reservoir. Additionally, the secondary working fluid circuit 126 can: originate at a coolant reservoir external to the pressure vessel 110; and terminate at an external heat sink. Thus, the secondary working fluid circuit 126 can additionally define a recycling loop that directs cooled secondary coolant from the heat sink and back into the coolant reservoir.

The secondary coolant can include a fluid configured to absorb and retain thermal energy. The secondary coolant can include a fluid characterized by a high heat capacity and thermal conductivity such as: water, liquid salt, oil, or liquid metallic. In one example, the secondary coolant includes salt configured to: absorb thermal energy transferred from the primary coolant 121 by the heat exchanger 120 region of the wall 111; and transport thermal energy to the external thermal power generation system.

In one implementation, the secondary working fluid circuit 126 is integrated within the wall 111 of the equipment section 150, thereby enabling secondary coolant to flow proximal and/or through the heat exchanger 120 contained in an infrastructure receptacle 118 of the equipment section 150.

### 5.6 Liners+Sleeve

Generally, the pressure vessel 110 includes a set of liners 130 configured to seal interior volumes of the pressure vessel 110—including the primary internal volume 116 and the set of infrastructure receptacles 118—from the wall 111 of the pressure vessel 110 (e.g., formed of the set of structural layers 112).

For example, the pressure vessel 110 can include a set of internal liners: a first set of liners 130 lining interior surfaces of the wall 111 encapsulating the primary internal volume 116; a second set of liners 130 lining interior surfaces of the wall 111 encapsulating a first infrastructure receptacle 118 containing the heat exchanger 120; a third set of liners 130 lining interior surfaces of the wall 111 encapsulating a second infrastructure receptacle 118 containing the pump 122; a fourth set of liners 130 lining interior surfaces of the slots of the condensation section 160; etc.

Additionally, the pressure vessel 110 can include an outer liner (“hereinafter the “outer sleeve”) applied to an outer surface of the wall 111 formed of the set of structural layers 112 arranged in the column. The outer sleeve can be configured to protect the pressure vessel 110 from external elements, such as including soil corrosion and/or other environmental exposures.

In one implementation, the set of internal liners and the outer sleeve can be formed of a corrosion-resistant material—such as including 316 stainless, 316L stainless, zirconium, various zircaloy alloys, various inconel alloys, various hastelloy alloys, and/or other high-temperature rated materials—configured to withstand repeated heating and cooling cycles (e.g., during startup and shutdown) without fracturing or failing. Furthermore, the set of internal liners—formed of the stainless steel material—exhibit chemical compatibility with the primary coolant (e.g., water), thereby minimizing a rate of corrosion of these internal liners due to contact with the primary coolant.

Additionally or alternatively, in another implementation, each internal liner, in the set of internal liners, can define: an inner layer encapsulating internal volumes of the pressure vessel 110 (e.g., the primary internal volume 116, the set of infrastructure receptacles 118); and an outer layer affixed to the inner layer and interposed between the inner layer and the wall 111 of the pressure vessel 110. In this implementation, the inner layer can be formed of a stainless steel material and the outer layer can be formed of a carbon steel material (e.g., structural steel). For example, the inner layer can define a thin sheet of 316 stainless steel and the outer layer can define a thicker sheet of structural steel. Therefore, the thinner inner layer can be configured to: prevent leakage of primary coolant from the primary internal volume 116 and/or other volumes contacting the primary fluid circuit; withstand nuclear radiation exposure; and resist corrosion from high-temperature, high-pressure primary coolant contacting the inner layer. The thicker outer layer—formed of structural steel—can be configured to provide additional structural support to the inner layer and the set of structural layers 112 forming the wall 111.

### 5.6.1 Liner Seat+Metallic Seals

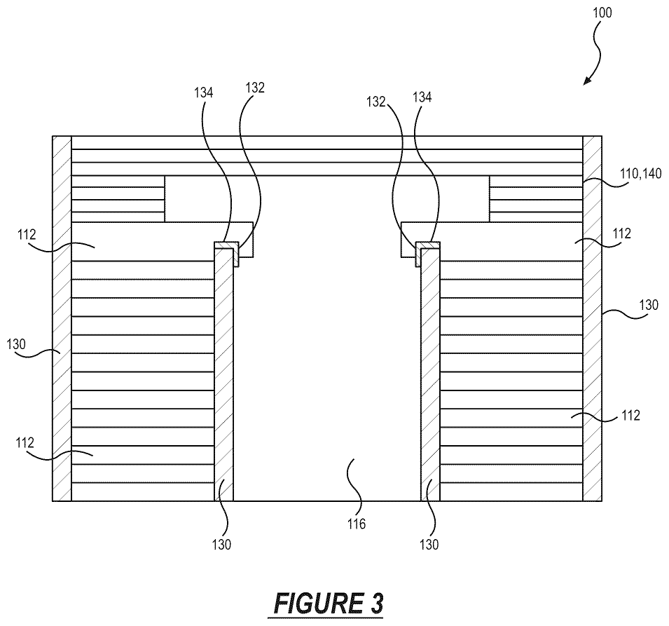

In one variation, as shown in FIG. 3, the pressure vessel 110 can define a set of liner seats 132 configured to receive and constrain the set of liners 130 responsive to vertical growth of liners due to temperature fluctuations within the pressure vessel 110.

In particular, as the pressure vessel 110 increases in temperature during startup and, therefore, exhibits a temperature gradient, the set of liners 130—formed of a stainless steel material (e.g., 316 stainless steel, 316L stainless steel)—experience vertical growth at a higher growth rate than the wall 111 formed of the set of structural layers 112 due to a difference in coefficients of thermal expansions of the stainless steel material and the structural steel material of the set of structural layers 112. The pressure vessel 110 can thus incorporate the set of liner seats 132 in order to prevent accumulation of a height differential between the set of liners 130 and the wall 111 across a height of the pressure vessel 110.

For example, the set of liner seats 132 can be machined into the set of structural layers 112 at set vertical intervals to accommodate an expected differential expansion while maintaining structural alignment between the set of liners 130 and structural layers 112 in the set of structural layers 112. Each liner seat 132, in the set of liner seats 132, can define a recessed geometry configured to receive a portion of a liner while allowing controlled vertical growth of the liner. The liner seat 132 can define a seat depth configured to laterally constrain the liner while permitting vertical displacement and/or growth of the liner. Furthermore, in one example, the liner seat 132 can define a seat geometry including chamfered edges configured to reduce stress concentration and facilitate liner movement during thermal cycling.

In one implementation, the system 100 can include a set of metallic seals 134 integrated within the set of liner seats 132 and configured to maintain a seal between each liner and the wall 111 while enabling differential thermal expansion. Each metallic seal 134 can be positioned within the liner seat 132 to form a compliant interface between the liner and the wall 111. The metallic seal 134 can deform elastically and/or plastically to accommodate vertical liner movement while maintaining contact pressure sufficient to prevent leakage of primary working fluid into the wall 111. For example, the metallic seal 134 can be fabricated from deformable metals such as lead, copper, silver, or any other specialized sealing alloy(s) configured for high-temperature nuclear applications. Therefore, the metallic seal 134 can cooperate with the liner seat 132—integrated within the wall 111 of the pressure vessel 110—to seal the primary internal volume 116 and/or infrastructure receptacles 118 (or other internal volumes) from the wall 111 and, thus, prevent leakage of primary coolant into the wall 111 under varying temperature and/or pressure conditions within the pressure vessel 110, such as during startup, hot shutdown, cold shutdown, closure of the pressure vessel 110, etc.

### 6. Manufacturing & Assembly

Generally, the pressure vessel 110 is formed by sequentially stacking a set of structural layers 112 in a column to form a cylindrical wall 111 defining the primary internal volume 116 and the set of infrastructure receptacles 118. During assembly of the set of structural layers 112 into the column, additional components of the system 100—including the set of liners 130, the heat exchanger 120, the pump 122, etc.—can be inserted into the primary internal volume 116 and the set of infrastructure receptacles 118 accordingly, such as prior to stacking of a structural layer 112 onto the column that seals off these internal volumes.

The pressure vessel 110 and/or subsections of the pressure vessel 110 (e.g., the reactor section 140, the equipment section 150, the condensation section 160) can undergo various treatments—such as including corrective tolerance treatments (e.g., pressure application, grinding, planing) and/or heat treatments for curing interstitial layers 114 between structural layers 112—configured to increase mechanical stability of the column and prevent leaking of primary coolant from within the pressure vessel 110 outward through the wall 111.

### 6.1 Plate Manufacturing

Generally, each structural layer 112, in the set of structural layers 112, can be cut to exhibit a target profile corresponding to a particular section—including the reactor section 140, the equipment section 150, and/or the condensation section 160—of the pressure vessel 110.

In one implementation, the set of structural layers 112 can be formed of a carbon steel material (e.g., a structural steel). Alternatively, in another implementation, the set of structural layers 112 can be formed of a stainless steel material (e.g., 316/316L stainless). In this implementation, the set of liners 130—formed of the stainless steel material—can exhibit a coefficient of thermal expansion equivalent to the set of structural layers 112, thereby enabling the wall 111 of the pressure vessel 110 to exhibit approximately uniform vertical growth as the set of liners 130, thus reducing complexity of the system 100 by eliminating dissimilar material interfaces while maintaining corrosion resistance throughout the wall 111 of the pressure vessel 110.

In one implementation, the set of structural layers 112 can be cut to exhibit a uniform diameter and a non-uniform (or variable) height. For example, the set of structural layers 112 can be cut to define a cylindrical geometry characterized by a: uniform diameter between ten feet and fifteen feet; and a non-uniform plate height approximately between one inch and five inches. In this example, the column can exhibit a column height exceeding thirty feet. In particular, in one example, the set of structural layers 112 can exhibit a diameter of approximately 12 feet and the column can exhibit a height of approximately 60 feet.

Each structural layer 112 can be machined to include a set of alignment features 170 configured to: enable alignment between structural layers 112 during assembly of the column formed of the set of structural layers 112; and/or define an interior volume—when aligned to adjacent alignment features of adjacent structural layers 112 in the column—spanning multiple structural layers 112 and/or configured to receive liners 130, infrastructure equipment (e.g., heat exchanger 120, pump 122), retention features (e.g., bolts, a threaded rod), etc.

For example, a first subset of structural layers 112, in the set of structural layers 112, configured to form the reactor section 140, can be cut to include a first set of apertures such that the first subset of structural layers 112 defines the primary internal volume 116 when stacked in the column. A second subset of structural layers 112, in the set of structural layers 112, configured to form the equipment section 150, can be cut to include a second set of apertures such that the second subset of structural layers 112 defines the set of infrastructure receptacles 118 when stacked in the column. A third subset of structural layers 112, in the set of structural layers 112, configured to form the condensation section 160, can be cut to include a third set of apertures such that the third subset of structural layers 112 defines the set of condensation chambers 162 and the set of airflow slots 164 when stacked in the column. The set of structural layers 112 can be cut via various cutting techniques, such as including laser cut, plasma cut, oxy-fuel, waterjet, CNC machining, etc.

In one implementation, the set of alignment features 170 (e.g., slots, apertures) can be cut oversized to account for tolerances during stacking of the set of structural layers 112. Therefore, by oversizing these alignment features 170, components of the system 100 can be inserted through inner volumes—formed via alignment of alignment features 170 across multiple structural layers 112—that may exhibit narrowed widths as additional structural layers 112 are added to the column.

Furthermore, in one variation, the set of structural layers 112 can be cut to define a chamfered edge—rather than 90-degree corners—on interior walls of the set of structural layers 112. By including a chamfered edge, additional components of the system 100—such as including the set of liners 130, the heat exchanger 120 (or a stainless steel container pre-loaded with the heat exchanger 120), the pump 122 (or a stainless steel container pre-loaded with the pump 122), alignment features 170, etc.—can be inserted through and/or into interior volumes of the column with less risk of interference due to hard edges or system wear due to collision of these components with hard edges.

In one variation, rather than cut whole plates—such as an annular structure characterized by a cross-section of equivalent length and width—half plates can be cut and further manufactured to fuse two half plates into a singular whole plate. In this variation, by cutting and fusing half plates to form whole plates, materials and costs associated with these materials can be reduced.

### 6.1.1 Plate Finishing

After cutting the set of structural layers 112, the set of structural layers 112 can undergo a set of cleaning treatments—such as including grinding, deburring, coating, flattening, etc.—configured to promote: precise dimensional control of structural layers 112 forming the pressure vessel 110, such as by achieving target plate thicknesses; uniform surface texture for subsequent adhesive bonding and/or mechanical fastening operations; and removal of imperfections generated during cutting, such as including raised metal edges that may interfere with plate alignment and/or sealing between plates in the column.

The set of structural layers 112 can then be treated with a surface treatment—such as including high velocity oxy-fuel (or “HVOF”), hot-dip galvanizing, cold-dip galvanizing, arc cladding—configured to improve corrosion resistance and structural integrity of the pressure vessel 110. Finally, the set of structural layers 112 can be machined to include a set of precision features, such as including surface finishes and/or datums required for proper alignment of plates during assembly. For example, the set of structural layers 112 can be machined to include raceways—including specific surface finishes—for installment of gaskets during assembly of the pressure vessel 110. In another example, the set of structural layers 112 can be machined to include an array of bolt holes configured to receive an array of bolts—extending between plates arranged in the column during the assembly period—to provide structural support to the column and prevent concentration of stresses on the column at a singular point. In another example, the set of structural layers 112 can be machined to include a surface pattern to allow for improved grip of gaskets or improved adherence of interstitial layers 114.

### 6.2 Pressure Vessel Assembly

During an assembly period, the set of structural layers 112 can be sequentially arranged in a column to form the pressure vessel 110.

In particular, during the assembly period: a first subset of structural layers 112, in the set of structural layers 112, can be arranged in a column to form the reactor section 140 defining the primary internal volume 116; a second subset of structural layers 112, in the set of structural layers 112, can be arranged in the column—above and contiguous the reactor section 140—to form the equipment section 150 defining the set of infrastructure receptacles 118; and a third subset of structural layers 112, in the set of structural layers 112, can be arranged in the column—above and contiguous the equipment section 150—to form the condensation section 160 defining the set of condensation chambers 162 and airflow slots 164.

Furthermore, during stacking of structural layers 112 to form the column (i.e., the wall 111 of the pressure vessel 110), additional components of the system 100—including the set of liners 130, the heat exchanger 120, the pump 122, etc.—can be inserted into corresponding internal volumes of the pressure vessel 110 prior to sealing of the pressure vessel 110 via application of additional plates onto the column.

### 6.2.1 Application of Adhesive Coating

Generally, during the assembly period, an interstitial layer 114—formed of an adhesive coating—can be applied to each subsequent structural layer 112, in the set of structural layers 112, before adding the subsequent structural layer 112 to the column and thus affixing the subsequent structural layer 112 to a preceding structural layer 112 on the column. For example, a first structural layer 112 can be located on a build surface. An interstitial layer 114 can then be applied to a surface of a second structural layer 112. Alternately, the interstitial layer 114 can be applied to the upper/exposed surface of the first structural layer 112. The second structural layer 112 can then be: coaxially aligned to the first structural layer 112 with the surface of the second structural layer 112—including the interstitial layer 114—facing the first structural layer 112 on the build surface; and stacked onto the first structural layer 112—with various alignment features 170 machined into these plates aligned accordingly—to form the column (i.e., the wall 111 of the pressure vessel 110).

In one implementation, the adhesive coating can be formed of a soft material (e.g., a brazing alloy): exhibiting a first melting point less than a second melting point of the set of structural layers 112; and configured to form a chemical bond with surfaces of the set of structural layers 112. For example, a Copper, Silver, and/or Nickel can be rolled into a sheet (or laser cut, stamped, etc.) to form an interstitial layer 114 applied to a surface of a structural layer 112. The column—including a set of interstitial layers 114 interposed between structural layers 112 in the set of structural layers 112—can then be heated to the melting point of the soft material (e.g., Copper, Silver, and/or Nickel), forming the interstitial layer 114 to cure the set of interstitial layers 114 to the set of structural layers 112. Alternatively, in another implementation, the adhesive coating can be formed of a ceramic material.

### 6.2.2 Corrective Actions

Furthermore, in response to misalignment between contiguous plates in the column—such as characterized by an offset between alignment features 170 exceeding a threshold tolerance—and/or in response to variability in column height or plate thickness, a corrective action can be executed to improve alignment between plates and/or increase column uniformity in Block S180.

For example, pressure can be applied to the column—such as via a hydraulic or pneumatic press—in a particular direction in order to mechanically adjust positions of the set of structural layers 112. Additionally or alternatively, in another example, a high-velocity oxy-fuel (or “HVOF”) coating can be applied to surfaces of the structural layers 112 in order to increase thickness of the structural layers 112 to achieve: a substantially flat plate surface; a target thickness defined for each structural layer 112; and/or a target height defined for the column and/or subsections of the column (i.e., the reactor section 140, the equipment section 150, the condensation section 160). Additionally or alternatively, in another example, a shim plate—defining a variable thickness profile—can be machined and installed between specific structural layers 112, in the set of structural layers 112, in order to compensate for accumulated tolerance errors. In one example, a shim plate can be installed at regular intervals (e.g., every 10 structural layers 112) within the column. Additionally or alternatively, in yet another example, an upper structural layer 112, in the set of structural layers 112, defining a top of the column can be ground and/or planed to remove excess material from an upper surface of the upper structural layer 112 and thus achieve a substantially flat upper surface and a uniform height defined for the column.

In particular, in one example, during an assembly period including the first, second, and third assembly periods, in response to installing a target quantity of structural layers (e.g., every 5 structural layers, every 10 structural layers, every 20 structural layers) in the set of structural layers, a height profile of a top structural layer in the set of structural layers forming the column can be measured. Based on this height profile, a corrective plate defining a variable thickness corresponding to the height profile—such that the variable thickness of the corrective plate offsets differences in heights across the height profile—can be machined. An interstitial layer can then be applied to a bottom surface of the corrective plate, and the corrective plate can be affixed to the top structural layer in order to achieve a uniform height, from the build surface, across an upper surface of the corrective plate—opposite the bottom surface—with the corrective plate coaxially aligned to the top structural layer and the base plate.

### 6.2.3 Assembly: Reactor Section

In one implementation, a first subset of structural layers 112, in the set of structural layers 112, can be arranged in a column to form the reactor section 140 of the pressure vessel 110.

In particular, in this implementation, during a first assembly period, a base structural layer 112 can be located on a build surface. Then, during the first assembly period, a first subset of structural layers 112, in a set of structural layers 112, can be assembled into the reactor section 140 of the column—defining the primary internal volume 116 configured to house a nuclear fuel—by, for each structural layer 112 in the first subset of structural layers 112: applying an interstitial layer 114 to a surface of the structural layer 112; coaxially and radially aligning the structural layer 112 to the base structural layer 112 and/or aligning corresponding machined features between the structural layer 112 and a preceding structural layer 112 in the column; and affixing the structural layer 112 to the preceding structural layer 112, in the first set of structural layers 112, in the column via the interstitial layer 114 interposed between the structural layer 112 and the preceding structural layer 112, the first structural layer 112 coaxially aligned to the preceding structural layer 112 and the base structural layer 112.

For example, a first interstitial layer 114 can be applied to a first surface of a first structural layer 112 in the first subset of structural layers 112. The first structural layer 112 can then be: coaxially aligned to the base structural layer 112; aligned to corresponding machined features of the base structural layer 112; and affixed to the base structural layer 112 via the first interstitial layer 114 interposed between the first structural layer 112 and the base structural layer 112, the first structural layer 112 coaxially aligned to the base structural layer 112. Then, a second interstitial layer 114 can be applied to a second surface of a second structural layer 112 in the first subset of structural layers 112. The second structural layer 112 can then be: coaxially aligned to the first structural layer 112; aligned to corresponding machined features of the first structural layer 112; and affixed to the first structural layer 112 via the second interstitial layer 114 interposed between the second structural layer 112 and the first structural layer 112, the second structural layer 112 coaxially aligned to the base structural layer 112 and the first structural layer 112. This process can then be repeated for each structural layer 112 in the first subset of structural layers 112 to form the reactor section 140 of the pressure vessel 110 defining the primary internal volume 116.

The first subset of structural layers 112—forming the reactor section 140 of the pressure vessel 110—can then be heated to a target temperature and for a target duration—defined for the adhesive coating forming the set of interstitial layers 114—to cure interstitial layers 114 to the first subset of structural layers 112.

The set of interior liners—encapsulating the primary internal volume 116—can then be inserted into the reactor section 140 to mate with the interior surface of the wall 111 formed by the first subset of structural layers 112 arranged in the column. For example, a metal tube (e.g., a stainless steel tube) can be inserted into the primary internal volume 116 to form an interior liner 130 interposed between the wall and the primary internal volume 116. Alignment features 170 can also be inserted into corresponding machined features of the first subset of structural layers 112 during assembly of the reactor section 140.

Furthermore, throughout assembly of the first subset of structural layers 112 to form the reactor section 140, corrective actions (e.g., as described above), can be selectively applied to the column to achieve tolerances for column height, plate alignment, plate thickness, etc. For example, as described above, the first subset of structural layers 112 can be machined to include an array of bolt holes configured to receive an array of bolts extending between plates arranged in the column during the assembly period. During the assembly period, the array of bolts can be inserted into the array of bolt holes to provide structural support to the reactor section 140 of the pressure vessel 110.

### 6.2.4 Assembly: Equipment Section

In one implementation, a second subset of structural layers 112, in the set of structural layers 112, can be arranged in the column—vertically above and contiguous the reactor section 140—to form the equipment section 150 of the pressure vessel 110.

In particular, during a second assembly period succeeding the first assembly period, a second subset of structural layers 112, in the set of structural layers 112, can be assembled into the equipment section 150 of the column—defining the set of infrastructure receptacles 118 configured to retain the heat exchanger 120 and the pump 122—by, for each structural layer 112 in the second subset of structural layers 112: applying an interstitial layer 114 to a surface of the structural layer 112; coaxially and radially aligning the structural layer 112 to the first subset of structural layers 112 of the reactor section 140; and affixing the structural layer 112 to a preceding structural layer 112, in the second subset of structural layers 112, in the column via the interstitial layer 114 interposed between the structural layer 112 and the preceding structural layer 112, the structural layer 112 coaxially aligned to the preceding structural layer 112 and the first subset of structural layers 112. This process can thus be repeated for each structural layer 112 in the second subset of structural layers 112 to form the equipment section 150 of the pressure vessel 110 defining the set of infrastructure receptacles 118.

The second subset of structural layers 112—forming the equipment section 150 of the pressure vessel 110—can then be heated to a target temperature and for a target duration—defined for the adhesive coating forming the set of interstitial layers 114—to cure interstitial layers 114 to the second subset of structural layers 112.

After curing the adhesive coating to the second subset of structural layer 112, the set of interior liners—encapsulating the set of infrastructure receptacles 118—can then be inserted into interior volumes of the equipment section 150 to mate with interior surfaces of the wall 111 formed by the second subset of structural layers 112 arranged in the column. Alignment features 170 can also be inserted into corresponding machined features of the second subset of structural layers 112 during assembly of the equipment section 150. Furthermore, throughout assembly of the second subset of structural layers 112 to form the equipment section 150, corrective actions (e.g., as described above), can be selectively applied to the column to achieve tolerances for column height, plate alignment, plate thickness, etc.

Furthermore, infrastructure components—such as including the heat exchanger 120, the pump 122, the pressurizer, etc.—can be inserted into corresponding infrastructure receptacles 118 of the equipment section 150.

In particular, in one implementation, each infrastructure component, in a set of infrastructure components—including the heat exchanger 120, the pump 122, the pressurizer, etc.—can initially be inserted into a container: defining an exterior surface; lined with a liner 130 applied to the exterior surface; and defining an internal volume configured to house the infrastructure component. The container—including the liner 130 applied to the exterior surface and containing the infrastructure component within the internal volume—can then be inserted into a corresponding infrastructure receptacle during the second assembly period to form the equipment section 150.

### 6.2.5 Assembly: Condensation Section

In one implementation, a third subset of structural layers 112, in the set of structural layers 112, can be arranged in the column—vertically above and contiguous the equipment section 150—to form the condensation section 160 of the pressure vessel 110.

In particular, during a third assembly period succeeding the second assembly period, a third subset of structural layers 112, in the set of structural layers 112, can be assembled into the condensation section 160 of the column—defining the set of condensation chambers 162 and the set of airflow slots 164—by, for each structural layer 112 in the third subset of structural layers 112: applying an interstitial layer 114 to a surface of the structural layer 112; coaxially and radially aligning the structural layer 112 to the second subset of structural layers 112 of the equipment section 150; and affixing the structural layer 112 to a preceding structural layer 112, in the third subset of structural layers 112, in the column via the interstitial layer 114 interposed between the structural layer 112 and the preceding structural layer 112, the structural layer 112 coaxially aligned to the preceding structural layer 112 and the second subset of structural layers 112. This process can thus be repeated for each structural layer 112 in the third subset of structural layers 112 to form the condensation section 160 of the pressure vessel 110 defining the set of condensation chambers 162 and the set of airflow slots 164. For example, the condensation chambers 162 can be formed via alignment of voids in a subset of structural layers 112 forming the condensation section 160, such that each condensation chamber defines a vertical cylindrical volume extending through multiple structural layers 112 to create continuous chambers spanning a height of the condensation section 160.

The third subset of structural layers 112—forming the condensation section 160 of the pressure vessel 110—can then be heated to a target temperature and for a target duration—defined for the adhesive coating forming the set of interstitial layers 114—to cure interstitial layers 114 to the third subset of structural layers 112.

After curing the adhesive coating to the third subset of structural layer 112, the set of interior liners—lining interior surfaces of the condensation section 160—can then be inserted into interior volumes of the condensation section 160 to mate with interior surfaces of the wall 111 formed by the third subset of structural layers 112 arranged in the column. Alignment features 170 can also be inserted into corresponding machined features of the third subset of structural layers 112 during assembly of the equipment section 150. Furthermore, throughout assembly of the third subset of structural layers 112 to form the equipment section 150, corrective actions (e.g., as described above), can be selectively applied to the column to achieve tolerances for column height, plate alignment, plate thickness, etc.

### 6.2.6 Variation: Babbitt Seal Between Liners & Structural Layers

In one variation, a babbitt material (e.g., an metal alloy) can be loaded into interior volumes of the pressure vessel 110 between the set of internal liners 130 and the set of structural layers 112 within the reactor section 140, the equipment section 150, and/or the condensation section 160. In particular, in this variation, a babbitt material can be loaded into an interior volume between an internal liner 130 and the set of structural layers 112 to: provide structural support for the set of liners 130 and the set of structural layers 112; improve heat transfer from the internal liner 130 into the set of structural layers 112; absorb tensions—such as due to heating and/or high temperature gradients—within the column and thus reduce risk of breakage of the set of structural layers 112, interstitial layers 114, and/or set of liners 130.

For example, a babbitt material—such as including an alloy, lead material, a lead eutectic material, a tin material, etc.—can be melted and poured into interior volumes of the column between the set of liners 130 and the set of structural layers 112, such that the set of liners 130 is fully trapped by the babbitt material and any gaps between the set of liners 130 and the set of structural layers 112 are filled by the babbitt material. In one example, the babbitt material can be selected and/or tuned to exhibit a target melting point (e.g., exceeding 600 degrees Fahrenheit) approximating and/or exceeding a standard operating temperature of the system 100, such that the babbitt material is relatively soft and will yield under thermal stresses (e.g., at the standard operating temperature). Therefore, the babbitt material can absorb inherent tensions or compressive forces that occur within the pressure vessel 110 (e.g., due to high temperatures). Furthermore, the babbitt material can creep at reactor operating temperatures and thus (slowly) flow to maintain contact with the (moving) set of liners 170 due to thermal expansion.

As a person skilled in the art will recognize from the previous detailed description and from the figures and claims, modifications and changes can be made to the embodiments of the invention without departing from the scope of this invention as defined in the following claims.

I claim:

1. A system comprising:
a pressure vessel:
comprising a wall formed of a set of structural layers arranged in a column;
defining a primary internal volume within the column;
defining a set of infrastructure receptacles arranged above the primary internal volume within the column;
defining a primary working fluid circuit extending between the primary internal volume and the set of infrastructure receptacles within the column; and
defining a secondary working fluid circuit adjacent and fluidly isolated from the primary working fluid circuit;
a nuclear fuel arranged within the primary internal volume;
a primary working fluid:
sealed within the pressure vessel; and
circulating between the nuclear fuel and the primary working fluid circuit;
a secondary working fluid circulating between the secondary working fluid circuit and an external power generation system;
a heat exchanger:
arranged within a first infrastructure receptacle in the set of infrastructure receptacles;
fluidly coupled to the primary working fluid circuit; and
configured to transfer thermal energy from the primary working fluid to the secondary working fluid; and
a set of liners:
comprising a set of interior liners arranged within the pressure vessel and lining interior surfaces of the wall facing the primary internal volume and the set of infrastructure receptacles;
comprising an exterior liner arranged about an exterior surface of the wall; and
configured to yield against the wall under internal pressure to form a seal between the wall and the primary internal volume.

2. The system of claim 1:
further comprising a pump:
arranged within a second infrastructure receptacle, in the set of infrastructure receptacles, above the first infrastructure receptacle within the column;
fluidly coupled to the primary working fluid circuit; and
configured to:
draw the primary working fluid upward from the primary internal volume and through the heat exchanger; and
direct the primary working fluid from an outlet of the pump toward the primary internal volume; and
wherein the heat exchanger is configured to cool the primary working fluid from a first temperature at a heat exchanger inlet to a second temperature at a heat exchanger outlet, the second temperature less than the first temperature.

3. The system of claim 1, wherein the set of structural layers comprises:
a first subset of structural layers arranged in the column and forming a reactor section defining the primary internal volume;
a second subset of structural layers arranged in the column above the first subset of structural layers and forming an equipment section defining the set of infrastructure receptacles; and
a third subset of structural layers arranged in the column above the second subset of structural layers and forming a condensation section defining:
a set of condensation chambers configured to receive steam from the primary working fluid circuit during emergency conditions; and
a set of airflow slots configured to enable airflow through the column to promote convection cooling.

4. The system of claim 1:
wherein the wall further comprises a set of interstitial layers interposed between structural layers in the set of structural layers;
wherein the set of structural layers comprises:
a first structural layer; and
a second structural layer; and
wherein the set of interstitial layers comprises a first interstitial layer abutting surfaces of the first structural layer and the second structural layer.

5. The system of claim 1:
wherein the nuclear fuel comprises a fissile material configured to heat the primary working fluid via a fission reaction;
wherein the primary working fluid:
comprises water;
is configured to moderate the fission reaction of the nuclear fuel; and
is configured to absorb thermal energy from the nuclear fuel; and
wherein the secondary working fluid comprises salt and is configured to:
cool the primary working fluid by absorbing thermal energy, transferred through the wall of the pressure vessel, from the primary working fluid; and
transport thermal energy to the external power generation system.

6. The system of claim 1:
wherein the wall further comprises a set of interstitial layers interposed between structural layers in the set of structural layers, the set of interstitial layers formed of a ceramic adhesive;
wherein the set of structural layers is formed of stainless steel; and
wherein the set of liners is formed of stainless steel.

7. The system of claim 1:
wherein the set of structural layers is formed of structural steel; and
wherein the set of interior liners is formed of:
a first layer of stainless steel configured to interface with internal volumes of the pressure vessel exposed to the primary coolant; and
a second layer of structural steel interposed between the first layer of stainless steel and the wall; and
wherein the exterior liner is formed of:
a third layer of stainless steel configured to interface with an environment external the pressure vessel; and
a fourth layer of structural steel interposed between the third layer of stainless steel and the wall.

8. The system of claim 1:
wherein the set of structural layers:
comprises a first subset of structural layers defining the primary internal volume; and
define a first coefficient of thermal expansion;
wherein the set of interior liners defines a second coefficient of thermal expansion exceeding the first coefficient of thermal expansion; and
wherein the first subset of structural layers cooperate to define a set of liner seats, each liner seat in the set of liner seats:
defining a recessed geometry configured to receive a portion of an interior liner, in the set of interior liners;
configured to constrain the interior liner responsive to vertical growth of the interior liner relative the first subset of structural layers due to a differential between the first coefficient of thermal expansion and the second coefficient of thermal expansion; and
defining a seat depth configured to laterally constrain the interior liner within the liner seat.

9. The system of claim 8, further comprising a set of metallic seals, each metallic seal, in the set of metallic seals:
integrated within a liner seat in the set of liner seats;
forming a compliant interface between the interior liner and the wall within the liner seat to enable vertical liner growth; and
maintaining a seal between the interior liner and the wall during a set of conditions of the pressure vessel.

10. The system of claim 1:
wherein the set of structural layers defines a cylindrical geometry characterized by:
a uniform diameter between ten feet and fifteen feet; and
a non-uniform plate height approximately between one inch and five inches; and
wherein the column exhibits a column height exceeding thirty feet.

11. The system of claim 1, wherein the pressure vessel is formed by:
during a first assembly period:
locating a base structural layer, in the set of structural layers, on a build surface;
arranging a first set of structural layers in a reactor section of the column defining the primary internal volume, comprising, for each structural layer in the first set of structural layers:
applying an interstitial layer to a surface of the structural layer;
coaxially and radially aligning the structural layer to the base structural layer; and
affixing the structural layer to a preceding structural layer, in the first set of structural layers, in the column via the interstitial layer interposed between the structural layer and the preceding structural layer, the first structural layer coaxially aligned to the preceding structural layer and the base structural layer;
heating the reactor section to a first target temperature to cure interstitial layers between structural layers in the first set of structural layers; and
applying a first subset of liners, in the set of liners, to interior walls of the reactor section encapsulating the primary internal volume;
during a second assembly period succeeding the first assembly period:
arranging a second subset of structural layers in an equipment section of the column defining a set of infrastructure receptacles, comprising, for each structural layer in the second subset of structural layers:
applying an interstitial layer to a surface of the structural layer;
coaxially and radially aligning the structural layer to the first set of structural layers;
affixing the structural layer to a preceding structural layer, in the second subset of structural layers, in the column via the interstitial layer interposed between the structural layer and the preceding structural layer, the structural layer coaxially aligned to the preceding structural layer, the first set of structural layers, and the base plate;
heating the equipment section to the first target temperature to cure interstitial layers between structural layers in the second subset of structural layers;
applying a second set of liners to interior walls of the equipment section lining the set of infrastructure receptacles;
installing a heat exchanger in a first infrastructure receptacle in the set of infrastructure receptacles; and
installing a pump in a second infrastructure receptacle, in the set of infrastructure receptacles, above the first infrastructure receptacle within the column; and
during a third assembly period succeeding the second assembly period:
arranging a third subset of structural layers in a condensation section of the column defining a set of slots configured to enable airflow through the column to promote convection cooling, comprising, for each structural layer in the third subset of structural layers:
applying an interstitial layer to a surface of the structural layer;
coaxially and radially aligning the structural layer to the second subset of structural layers; and
affixing the structural layer to a preceding structural layer, in the third subset of structural layers, in the column via the interstitial layer interposed between the structural layer and the preceding structural layer, the structural layer coaxially aligned to the preceding structural layer, the second subset of structural layers, the first set of structural layers, and the base plate.

12. A method for manufacturing a pressure vessel comprising:
during a first assembly period:
locating a base structural layer, in a set of structural layers, on a build surface;
arranging a first subset of structural layers, in the set of structural layers, in a column to form a reactor section of the pressure vessel defining a primary internal volume configured to house a nuclear fuel, comprising, for each structural layer in the first subset of structural layers:
applying an interstitial layer to a surface of the structural layer;
coaxially and radially aligning the structural layer to the base structural layer; and
affixing the structural layer to a preceding structural layer, in the first subset of structural layers, in the column via the interstitial layer interposed between the structural layer and the preceding structural layer, the first structural layer coaxially aligned to the preceding structural layer and the base structural layer;
heating the reactor section of the column to a first target temperature to cure interstitial layers between structural layers in the first subset of structural layers; and
applying a first set of liners to interior walls of the reactor section encapsulating the primary internal volume, the first set of liners configured to form a seal between the interior wall and the primary internal volume; and
during a second assembly period succeeding the first assembly period:
arranging a second subset of structural layers, in the set of structural layers, in the column to form an equipment section of the pressure vessel defining a set of infrastructure receptacles, comprising, for each structural layer in the second subset of structural layers:
applying an interstitial layer to a surface of the structural layer;
coaxially and radially aligning the structural layer to the first subset of structural layers; and
affixing the structural layer to a preceding structural layer, in the second subset of structural layers, in the column via the interstitial layer interposed between the structural layer and the preceding structural layer, the structural layer coaxially aligned to the preceding structural layer, the first subset of structural layers, and the base plate;
heating the equipment section of the column to a second target temperature to cure interstitial layers between structural layers in the second subset of structural layers;
applying a second set of liners to interior walls of the equipment section lining the set of infrastructure receptacles;
installing a heat exchanger in a first infrastructure receptacle in the set of infrastructure receptacles; and
installing a pump in a second infrastructure receptacle, in the set of infrastructure receptacles, above the first infrastructure receptacle within the column; and
during a third assembly period succeeding the second assembly period;
arranging a third subset of structural layers, in the set of structural layers, in the column to form a condensation section of the pressure vessel defining a set of slots configured to enable airflow through the column to promote convection cooling, comprising, for each structural layer in the third subset of structural layers:
applying an interstitial layer to a surface of the structural layer;
coaxially and radially aligning the structural layer to the second subset of structural layers; and
affixing the structural layer to a preceding structural layer, in the third subset of structural layers, in the column via the interstitial layer interposed between the structural layer and the preceding structural layer, the structural layer coaxially aligned to the preceding structural layer, the second subset of structural layers, the first subset of structural layers, and the base plate; and
heating the condensation section of the column to a third target temperature to cure interstitial layers between structural layers in the third subset of structural layers.

13. The method of claim 12, wherein arranging the third subset of structural layers in the condensation section of the column comprises arranging the third subset of structural layers in the condensation section of the column, arranged vertically above and contiguous the reactor section and the equipment section, to form a pressure vessel:
comprising a wall formed of the set of structural layers arranged in the column;
defining the primary internal volume within the column;
defining the set of infrastructure receptacles arranged above the primary internal volume within the column;
defining a primary working fluid circuit extending between the primary internal volume and the set of infrastructure receptacles within the column; and
defining a secondary working fluid circuit adjacent and fluidly isolated from the primary working fluid circuit;
a nuclear fuel arranged within the primary internal volume;
a primary working fluid:
sealed within the pressure vessel; and
circulating between the nuclear fuel and the primary working fluid circuit;
a secondary working fluid circulating between the secondary working fluid circuit and an external power generation system;
a heat exchanger:
arranged within a first infrastructure receptacle in the set of infrastructure receptacles;
fluidly coupled to the primary working fluid circuit; and
configured to transfer thermal energy from the primary working fluid to the secondary working fluid;
a set of liners:
comprising a set of interior liners arranged within the pressure vessel and lining interior surfaces of the wall facing the primary internal volume and the set of infrastructure receptacles; and
comprising an exterior liner arranged about an exterior surface of the wall; and
configured to yield against the wall under internal pressure to form a seal between the wall and the primary internal volume.

14. The method of claim 12, wherein arranging the first subset of structural layers in the column to form the reactor section comprises:
applying a first interstitial layer to a first surface of a first structural layer in the first subset of structural layers;
coaxially and radially aligning the first structural layer to the base structural layer;
affixing the first structural layer to the base structural layer via the first interstitial layer interposed between the first structural layer and the base structural layer, the first structural layer coaxially aligned to the base structural layer;
applying a second interstitial layer to a second surface of a second structural layer in the first subset of structural layers;
coaxially and radially aligning the second structural layer to the first structural layer; and
affixing the second structural layer to the first structural layer via the second interstitial layer interposed between the second structural layer and the first structural layer, the second structural layer coaxially aligned to the first structural layer and the base structural layer.

15. The method of claim 12, further comprising:
during a machining period preceding the first assembly period:
machining a first array of bolt holes arranged in a first circular pattern at a first radius in each structural layer in the first subset of structural layers; and
machining a second array of bolt holes arranged in a second circular pattern at a second radius in each structural layer in the second subset of structural layers, the first circular pattern and the second circular pattern configured to cooperate to provide resistance to internal pressure loads throughout the column;
during the first assembly period, inserting bolts through aligned bolt holes in adjacent structural layers in the first subset of structural layers; and
during the second assembly period, inserting bolts through aligned bolt holes in adjacent structural layers in the second subset of structural layers.

16. The method of claim 12:
wherein locating the base structural layer, in the set of structural layers, on the build surface comprises locating the base structural layer, in the set of structural layers, on the build surface, the set of structural layers formed of a first steel material;
wherein applying the interstitial layer to the surface of each structural layer in the first subset of structural layers comprises applying the interstitial layer, formed of a soft material, to the surface of each structural layer in the first subset of structural layers;
wherein applying the interstitial layer to the surface of each structural layer in the second subset of structural layers comprises applying the interstitial layer, formed of the soft material, to the surface of each structural layer in the second subset of structural layers;
wherein applying the interstitial layer to the surface of each structural layer in the third subset of structural layers comprises applying the interstitial layer, formed of the soft material, to the surface of each structural layer in the third subset of structural layers;
wherein applying the first set of liners to the interior walls of the reactor section comprises applying the first set of liners to the interior walls of the reactor section, the first set of liners formed of a second steel material;
wherein applying the second set of liners to the interior walls of the equipment section comprises applying the second set of liners to the interior walls of the equipment section, the second set of liners formed of the second steel material; and
further comprising, applying a third set of liners to exterior walls of the pressure vessel, the third set of liners formed of the second steel material.

17. The method of claim 12:
further comprising, during a preparation period preceding the first assembly period:
machining the first subset of structural layers to:
define the primary internal volume when arranged in the column; and
define a first set of alignment features;
machining the second subset of structural layers to:
define the set of infrastructure receptacles when arranged in the column; and
define a second set of alignment features;
machining the third subset of structural layers to:
define the set of slots and a set of condensation chambers when arranged in the column; and
define a third set of alignment features;
exposing the set of structural layers to a chemical reagent to remove contaminants from surfaces of the plate;
polishing the set of structural layers to achieve a target finish grade; and
applying a surface treatment to the set of structural layers;
wherein coaxially and radially aligning the structural layer to the base structural layer comprises:
coaxially aligning the structural layer to the base structural layer and the preceding structural layer; and
radially aligning a first subset of alignment features, in the first set of alignment features, of the structural layer with a second subset of alignment features, in the first set of alignment features, of the preceding structural layer;
wherein coaxially and radially aligning the structural layer to the first subset of structural layers comprises:
coaxially aligning the structural layer to the first subset of structural layers and the preceding structural layer; and
radially aligning a third subset of alignment features, in the second set of alignment features, of the structural layer with a fourth subset of alignment features, in the second set of alignment features, of the preceding structural layer; and
wherein coaxially and radially aligning the structural layer to the second subset of structural layers comprises:
coaxially aligning the structural layer to the second subset of structural layers and the preceding structural layer; and
radially aligning a fifth subset of alignment features, in the third set of alignment features, of the structural layer with a sixth subset of alignment features, in the third set of alignment features, of the preceding structural layer.

18. The method of claim 12, further comprising, during an assembly period comprising the first assembly period, the second assembly period, and the third assembly period, in response to installing a target quantity of structural layers in the set of structural layers:
measuring a height profile of a top structural layer in the set of structural layers forming the column;
machining a corrective plate defining a variable thickness corresponding to the height profile;
applying an interstitial layer to a bottom surface of the corrective plate;
affixing the corrective plate to the top structural layer to achieve a uniform height, from the build surface, across an upper surface of the corrective plate opposite the bottom surface, the corrective plate coaxially aligned to the top structural layer and the base plate.

19. A method for manufacturing a pressure vessel comprising:
during a first assembly period:
locating a base structural layer, in a set of structural layers, on a build surface;
arranging a first subset of structural layers, in the set of structural layers, in a reactor section of a column defining a primary internal volume configured to house a nuclear fuel, comprising, for each structural layer in the first subset of structural layers:
applying an interstitial layer to a surface of the structural layer;
coaxially and radially aligning the structural layer to the base structural layer; and
affixing the structural layer to a preceding structural layer, in the first subset of structural layers, in the column via the interstitial layer interposed between the structural layer and the preceding structural layer, the first structural layer coaxially aligned to the preceding structural layer and the base structural layer;
applying a first set of liners to interior walls of the reactor section encapsulating the primary internal volume, the first set of liners configured to form a seal between the interior wall and the primary internal volume; and
during a second assembly period succeeding the first assembly period:
arranging a second subset of structural layers, in the set of structural layers, in an equipment section of the column defining a set of infrastructure receptacles, comprising, for each structural layer in the second subset of structural layers:
applying an interstitial layer to a surface of the structural layer;
coaxially and radially aligning the structural layer to the first subset of structural layers; and
affixing the structural layer to a preceding structural layer, in the second subset of structural layers, in the column via the interstitial layer interposed between the structural layer and the preceding structural layer, the structural layer coaxially aligned to the preceding structural layer, the first subset of structural layers, and the base plate;
applying a second set of liners to interior walls of the equipment section lining the set of infrastructure receptacles;
installing a heat exchanger in a first infrastructure receptacle in the set of infrastructure receptacles; and
installing a pump in a second infrastructure receptacle, in the set of infrastructure receptacles, above the first infrastructure receptacle within the column.

20. The method of claim 19, further comprising, during a third assembly period succeeding the second assembly period;
arranging a third subset of structural layers, in the set of structural layers, in a condensation section of the column defining a set of slots configured to enable airflow through the column to promote convection cooling, comprising, for each structural layer in the third subset of structural layers:
applying an interstitial layer to a surface of the structural layer;
coaxially and radially aligning the structural layer to the second subset of structural layers; and
affixing the structural layer to a preceding structural layer, in the third subset of structural layers, in the column via the interstitial layer interposed between the structural layer and the preceding structural layer, the structural layer coaxially aligned to the preceding structural layer, the second subset of structural layers, the first subset of structural layers, and the base plate.
